(19) United States
(12) Patent Application Publication
(10) Pub. No.: US 2011/0050929 A1
(43) Pub. Date: Mar. 3, 2011

(54) CAMERA ARRAY

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/580,271

(22) Filed: Oct. 16, 2009

(30) Foreign Application Priority Data
Aug. 26, 2009 (CN) 200910306099.7

(51) Int. Cl. H04N 5/225

(52) U.S. Cl. 348/218.1; 348/E05.024

(57) ABSTRACT

A camera array includes a number of cameras. The number of cameras target a subject to be monitored, and capture images of the subject from different angles at one time to provide a composite image of the subject. The camera array can obtain more information about the subject.

### BACKGROUND

1. Technical Field

The present disclosure relates to an camera array.

2. Description of Related Art

Many video-equipped security systems utilize only a single camera, providing a single display at a time. As a result, some areas to be monitored can be neglected, with events occurring therein not captured for display.

### BRIEF DESCRIPTION OF THE DRAWINGS

FIG. 1 is a schematic diagram of a first exemplary embodiment of a camera array.

FIG. 2 is a schematic diagram of a second exemplary embodiment of a camera array.

FIG. 3 is a schematic diagram of a third exemplary embodiment of a camera array.

FIG. 4 is a schematic diagram of a fourth exemplary embodiment of a camera array.

FIG. 5 is a schematic diagram of a fifth exemplary embodiment of a camera array.

FIG. 6 is a schematic diagram of a sixth exemplary embodiment of a camera array.

### DETAILED DESCRIPTION

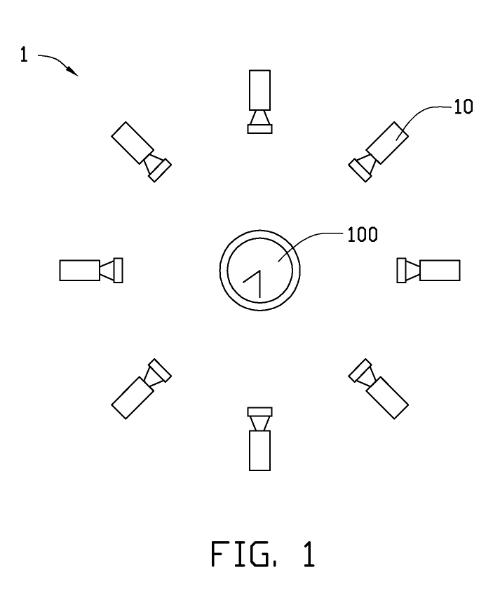

Referring to FIG. 1, a first embodiment of a camera array 1 monitors an subject, such as an alarm clock 100, for instance. The first embodiment of the camera array 1 includes a plurality of cameras 10. The plurality of cameras 10 are arranged in a circle. Distances between every two adjacent cameras are the same. The alarm clock 100 is located at the center of the circle. All the plurality of cameras 10 aims at the alarm clock 100. In other embodiments, the distances between every two adjacent cameras may be different.

In use, the plurality of cameras 10 is turned on at the same time, and captures images of the alarm clock 100 from different angles. The plurality of captured images make up a surrounding image of the alarm clock 100, such that complete information is available about the alarm clock 100.

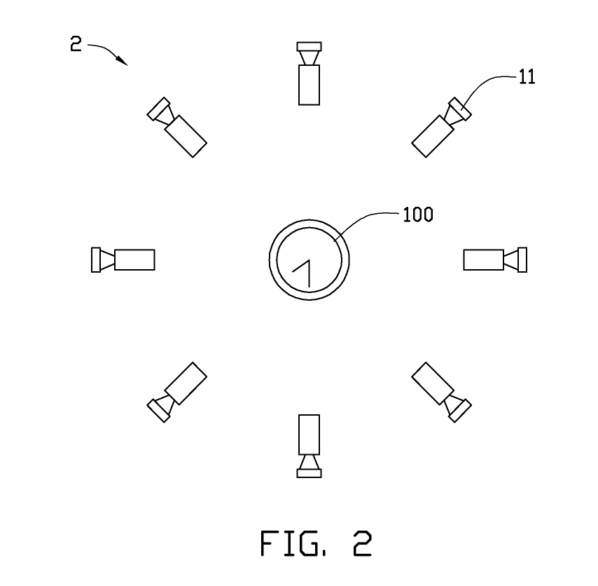

Referring to FIG. 2, a second embodiment of a camera array 2 monitors the environment surrounding the alarm clock 100, and comprises a plurality of cameras 11, arranged in a circle, with distances between every two adjacent cameras the same. The centre of the circle is the alarm clock 100. The plurality of cameras 11 faces outward from the alarm clock 100.

In use, the plurality of cameras 11 is turned on at the same time, and captures images of the environment surrounding the alarm clock 100 from as many different angles as there are cameras 11. As a result, a plurality of images is captured at one time, making up a composite image of the environment surrounding the alarm clock 100, providing additional information about the alarm clock 100.

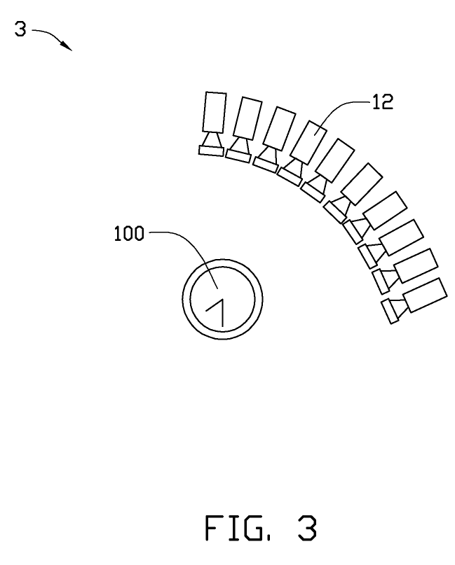

Referring to FIG. 3, a third embodiment of a camera array 3 monitors the alarm clock 100. The third embodiment of the camera array 3 includes a plurality of cameras 12. The plurality of cameras 12 is arranged in a curve. A centre of the curve is the alarm clock 100. The plurality of cameras 12 aims at the alarm clock 100. In other embodiments, the plurality of cameras 12 may be arranged in several curves.

In use, the plurality of cameras 12 is turned on at the same time, and captures image of the alarm clock 100 from different angles. The captured plurality of images make up a composite image of the alarm clock 100, such that an effective amount of information based on monitoring demand is available about the alarm clock 100.

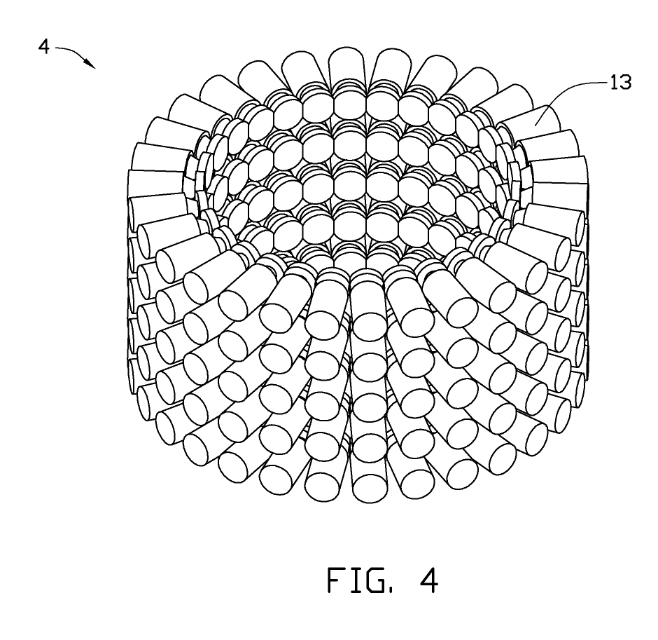

Referring to FIG. 4, a fourth embodiment of a camera array 4 monitors the alarm clock 100. The fourth embodiment of the camera array 4 includes a plurality of cameras 13. The plurality of cameras 13 is arranged in stacked circles. A center of one of the plurality circles is the alarm clock 100. The plurality of cameras 13 aims at the alarm clock 100.

In use, the plurality of cameras 13 is turned on at the same time, and captures images of the alarm clock 100 from different angles. The captured plurality of images make up a composite image of the alarm clock 100, such that an effective amount of information is available about the alarm clock 100.

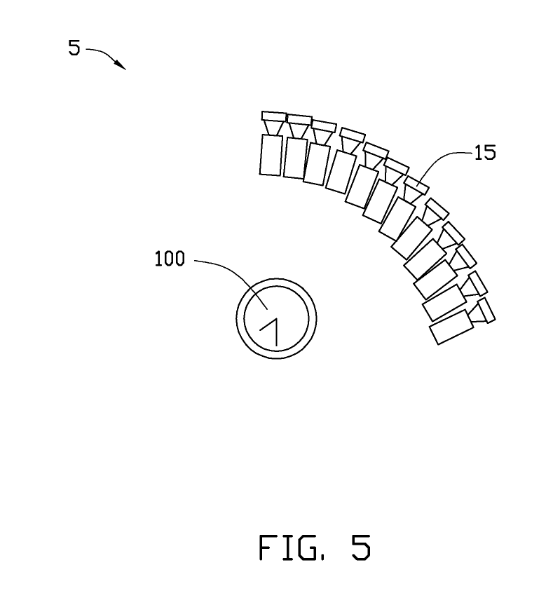

Referring to FIG. 5, a fifth embodiment of a camera array 5 monitors the environment surrounding the alarm clock 100. The fifth embodiment of the camera array 5 includes a plurality of cameras 15 arranged in a curve. The centre of the curve is the alarm clock 100. The plurality of cameras 15 faces away from the alarm clock 100. In other embodiments, the plurality of cameras 15 may be arranged in multiple curves.

In use, the plurality of cameras 15 is turned on at the same time, and captures images of the environment surrounding the alarm clock 100 from different angles. The captured plurality of images create a composite image of the environment surrounding the alarm clock 100. In making use of the composite image, an effective amount of information is available about the alarm clock 100.

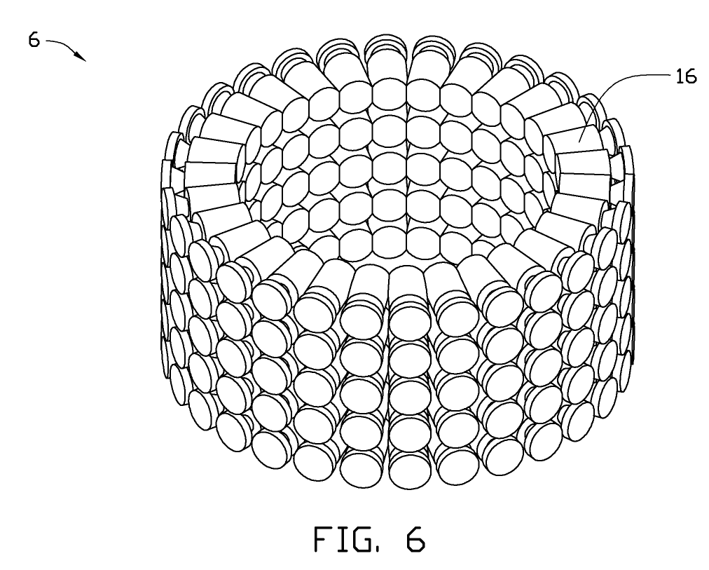

Referring to FIG. 6, a sixth embodiment of an camera array 6 monitors the environment surrounding the alarm clock 100. The sixth embodiment of the camera array 6 includes a plurality of cameras 16. The plurality of cameras 16 is arranged in stacked circles, with a centre of one of the circles being the alarm clock 100. The plurality of cameras 16 faces away from the alarm clock 100.

In use, the plurality of cameras 16 is turned on at the same time, and captures images of the environment surrounding the alarm clock 100 from different angles. As a result, a plurality of images can be obtained at the same time. The plurality of images make up a composite image of the environment surrounding the alarm clock 100. In making use of the composite image, an effective amount of information about the alarm clock 100 can be obtained than in the second embodiment.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A camera array comprising a plurality of first cameras, targeting a subject to be monitored and capturing images of the subject from different angles at one time to provide a composite image of the subject.

2. The camera array of claim 1, wherein the plurality of first cameras is arranged circularly at a constant distance.

3. The camera array of claim 1, wherein the plurality of first cameras is arranged circularly at varying distances.

4. The camera array of claim 1, wherein the plurality of first cameras is arranged in multiple circles.

5. The camera array of claim 1, wherein the plurality of first cameras is arranged in a circular curve at a constant distance.

6. The camera array of claim 1, wherein the plurality of first cameras is arranged in a circular curve at varying distances.

7. The camera array of claim 1, wherein the plurality of first cameras is arranged in multiple circular curves.

8. The camera array of claim 1, further comprising a plurality of second cameras, facing away from the subject, and capturing images of the environment surrounding the subject from different angles at one time, providing a composite image of the environment surrounding the subject.

9. The camera array of claim 8, wherein the plurality of second cameras is arranged circularly at a constant distance.

10. The camera array of claim 8, wherein the plurality of second cameras is arranged circularly at varying distances.

11. The camera array of claim 8, wherein the plurality of second cameras is arranged in multiple circles.

12. The camera array of claim 8, wherein the plurality of second cameras is arranged in a circular curve at a constant distance.

13. The camera array of claim 8, wherein the plurality of second cameras is arranged in a circular curve at varying distances.

14. The camera array of claim 8, wherein the plurality of second cameras is arranged in multiple circular curves.

15. A camera array comprising a plurality of cameras, facing away from a subject to be monitored, and capturing images of the environment surrounding the subject from different angles at one time, providing a composite image of the subject.

16. The camera array of claim 15, wherein the plurality of cameras is arranged circularly at a constant distance.

17. The camera array of claim 15, wherein the plurality of cameras is arranged circularly at varying distances.

18. The camera array of claim 15, wherein the plurality of cameras is arranged in several circles.

19. The camera array of claim 15, wherein the plurality of cameras is arranged in a circular curve.

20. The camera array of claim 15, wherein the plurality of cameras is arranged in multiple circular curves.
